(19) United States
(12) Patent Application Publication
(10) Pub. No.: US 2007/0168604 A1
(43) Pub. Date: Jul. 19, 2007

(54) Information recording apparatus and method for controlling the same

(75) Inventors: Yoriharu Takai, Kodaira-shi (JP); Kenji Yoshida, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/585,189

(22) Filed: Oct. 24, 2006

(30) Foreign Application Priority Data
Jan. 17, 2006 (JP) 2006-009169

(51) Int. Cl. G06F 13/00

(52) U.S. Cl. 711/113

(57) ABSTRACT

According to one embodiment, an information recording apparatus includes an input which receives a command, a disk-like recording medium, a non-volatile memory serving as a cache memory for the disk-like recording medium, and a control unit for flashing information recorded in the non-volatile memory to the disk-like recording medium in accordance with a flash command input into the input so as to make a vacant region inside the non-volatile memory.

### CROSS-REFERENCE TO RELATED APPLICATIONS

This application is based upon and claims the benefit of priority from Japanese Patent Application No. 2006-009169, filed Jan. 17, 2006, the entire contents of which are incorporated herein by reference.

### BACKGROUND

1. Field

One embodiment of the invention relates to an information recording apparatus, in which information is written to a disk-like recording medium having a large capacity such as a hard disk by using a non-volatile semiconductor memory as a cache, and a method for controlling the same.

2. Description of the Related Art

As is well known, a hard disk has become an information recording medium having a large capacity and high reliability in recent years, and therefore, it has prevailed in many fields for use in recording, for example, computer data, video data, voice data and the like. In addition, the hard disk has been sufficiently reduced in size to be mounted in portable electronic equipment.

In view of this, in a miniaturization-oriented information recording apparatus by the use of the hard disk, a non-volatile memory, to and from which information can be written and read at high speed, has been recently used as a cache memory for the hard disk, so that battery power can be saved by increasing information writing/reading speed, and further, reducing access times of the hard disk, that is, information writing/reading times to and from the hard disk.

In other words, the information recording apparatus of this type has allowed the non-volatile memory to write and read the information with respect to the outside and to transfer the information to the hard disk, thereby apparently writing and reading the information at an increased speed with respect to the outside and reducing the access times of the hard disk. Therefore, it has been referred to also as a non-volatile (NV)-cache-compatible hard disk drive (HDD), to be thus standardized.

Here, in the information recording apparatus, in which the information has been written and read at an increased speed and the access times of the hard disk have been reduced, as described above, a flash memory has been devised to be used as the non-volatile memory serving as a cache. Since a flash memory has had the limitation on rewriting times (for example, about 100,000 times), the flash memory has been excessively liable to make an error beyond the limitation, and therefore, it has been reduced in reliability.

As a consequence, the information recording apparatus, in which the information has been recorded on the hard disk by the use of the non-volatile memory serving as the cache, has been earnestly demanded to achieve improvements not only such that power consumption has been saved by reducing the driving times of the hard disk but also such that information writing/reading operations have been efficiently controlled in consideration of the limitation on the rewriting times by the non-volatile memory or ease of use by a user.

Jpn. Pat. Appln. KOKAI Publication No. 2004-55102 discloses a large-capacity storage medium having both of a memory card and an HDD mounted thereon. In such a large-capacity storage medium, data on the memory card acquired from, for example, the outside can be backed up onto a hard disk serving as a magnetic recording medium, and further, data stored on the hard disk can be transferred to the memory card, from which the data can be fetched.

In addition, Japanese Patent No. 3407317 discloses a portable storage device by the use of a flash memory. Japanese Patent No. 3407317 discloses a data managing method for suppressing an increase in rewriting times only in a specific region in order to solve a problem that an error is liable to occur as the rewriting times are increased (for example, 100,000 times) in the flash memory.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram schematically illustrating the configuration of an information recording apparatus in an embodiment according to the present invention;

FIG. 2 is a diagram illustrating a recording region in a flash memory for use in the information recording apparatus in the embodiment;

FIG. 3 is a diagram illustrating a counter of a flash memory interface for use in the information recording apparatus in the embodiment;

FIG. 4 is a block diagram illustrating the configuration of one example of a controller for use in the information recording apparatus in the embodiment;

FIG. 5 is a block diagram illustrating the configuration of one example of a host apparatus connected to the information recording apparatus in the embodiment;

FIG. 6 is a flowchart illustrating one example of processing by the host apparatus in the embodiment; and

FIG. 7 is a flowchart illustrating one example of processing by the controller in the embodiment.

### DETAILED DESCRIPTION

Various embodiments according to the invention will be described hereinafter with reference to the accompanying drawings. In general, according to one embodiment of the invention, an information recording apparatus includes: an input which receives a command; a disk-like recording medium; a non-volatile memory serving as a cache memory for the disk-like recording medium; and a control unit for flashing information recorded in the non-volatile memory to the disk-like recording medium in accordance with a flash command input into the input so as to make a vacant region inside the non-volatile memory.

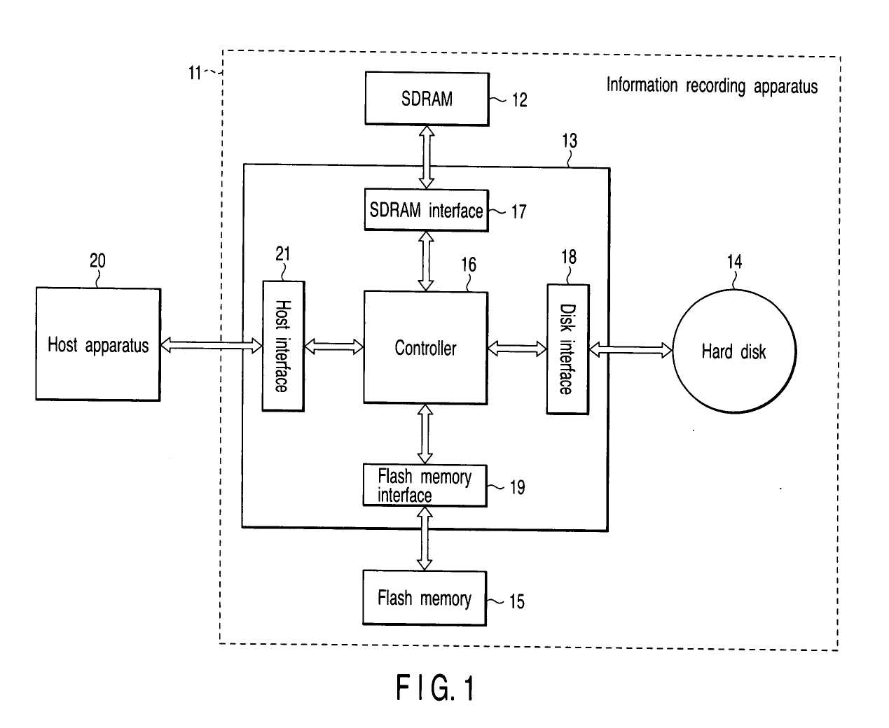

FIG. 1 schematically illustrates an information recording apparatus 11 in the embodiment. The information recording apparatus 11, described below, is exemplified by an NV-cache-compatible HDD standardized by the Non Volatile Cache Command Proposal for ATA8-ACS Revision 5 or the like.

Specifically, the information recording apparatus 11 includes an SDRAM 12 functioning as a buffer, a one-chip LSI 13 incorporating various kinds of circuit blocks therein, a hard disk 14 serving as a disk-like recording medium of a large capacity, a flash memory 15 serving as a non-volatile memory functioning as a cache for the hard disk 14, and the like.

On the LSI 13 is mounted a controller 16 serving as a control unit for performing a comprehensive control in the case where the information recording apparatus 11 executes a variety of processings. Additionally, on the LSI 13 are mounted an SDRAM interface 17 for connecting the controller 16 and the SDRAM 12 to each other in such a manner as to freely transfer information therebetween, a disk interface 18 for connecting the controller 16 and the hard disk 14 to each other in such a manner as to freely transfer information therebetween, a flash memory interface 19 for connecting the controller 16 and the flash memory 15 to each other in such a manner as to freely transfer information therebetween, and a host interface 21 for connecting the controller 16 and an outside host apparatus 20 to each other in such a manner as to freely transfer information therebetween.

Here, the host apparatus 20 is exemplified by a personal computer (PC) or the like. The host apparatus 20 can write and read information by using the information recording apparatus 11 when, for example, predetermined application software is executed, and further, can store finally resultant information in the information recording apparatus 11.

In this case, the host apparatus 20 issues a command requesting to write information in the information recording apparatus 11 and a command requesting to read information from the information recording apparatus 11. Such a command is supplied to the controller 16 via the host interface 21, and then, is analyzed.

In this manner, the controller 16 controls the SDRAM 12, the flash memory 15 and the hard disk 14 in such a manner as to selectively write the information supplied from the host apparatus 20 therein and read the information to the host apparatus 20 therefrom. Here, the controller 16 has the function of transferring the information among the SDRAM 12, the flash memory 15 and the hard disk 14.

The controller 16 basically stores information to be written in the flash memory 15 at an information writing request from the host apparatus 20. Then, the controller 16 transfers and stores the information stored in the flash memory 15 to and in the hard disk 14 at a predetermined timing when, for example, a recording region in the flash memory 15 is occupied in excess of a given quantity.

In contrast, the controller 16 reads information to be requested from the hard disk 14 at an information reading request from the host apparatus 20, and then, outputs it to the host apparatus 20. In this case, if the requested information is stored in the flash memory 15, the controller 16 reads the information from the flash memory 15, and then, outputs it to the host apparatus 20.

Here, the information (data) to be written in the flash memory 15 is added with an error correcting code. Thus, the data to be read from the flash memory 15 is subjected to error correction based on the error correcting code.

Moreover, the data to be recorded in the hard disk 14 also is added with an error correcting code. Thus, the data to be read from the hard disk 14 is subjected to error correction based on the error correcting code.

In the present embodiment, a system of a much higher error correcting ability is adopted for the error correction, to which the data to be recorded in the hard disk 14 is subjected, in comparison with the error correction, to which the data to be recorded in the flash memory 15 is subjected. In other words, the data recorded in the hard disk 14 has reliability much higher than the data recorded in the flash memory 15.

Additionally, in the present embodiment, the information is written in and read from the flash memory 15 in 2 Kbytes, and further, is erased in 128 Kbytes. Moreover, a device in the flash memory 15 is degraded as the writing and reading times increase, and therefore, an error generating rate becomes higher. In view of this, rewriting times are defined as about 100,000 times as information for insuring the performance of the device.

Here, explanation will be made on commands required in describing the present embodiment out of various kinds of commands, which are set based on the above-described standard and can be executed by the information recording apparatus 11. First of all, a first command is designed to designate a logical block address (LBA) of information to be written in the flash memory 15 out of the LBAs on the hard disk 14.

Furthermore, a second command is designed to designate an LBA of information to be written in the flash memory 15, like the first command. Simultaneously, the second command requires to read the information recorded in the LBA from the hard disk 14, and further, to write the read information in the flash memory 15.

The first and second commands correspond to PI=0 and PI=1, respectively, in Add LBA(s) to NV Cache Pinned Set in the above-described standard. An LBA, at which the information is instructed to be stored in the flash memory 15 by the host apparatus 20, is added with “pinned” attribute information.

A third command is designed to designate an LBA on the hard disk 14, and then, to require to write the information. In the case where the third command is issued from the host apparatus 20, the controller 16 checks as to whether or not the “pinned” attribute information is assigned to the LBA required to be written. If the result is affirmative, the information is written in a region corresponding to the LBA required to be written in the flash memory 15.

In contrast, if the pinned attribute information is not assigned to the LBA required to be written, the controller 16 determines by its own judgment whether the information is written in a region corresponding to a designated LBA in the flash memory 15, or the information is written at the designated LBA in the hard disk 14, and then, performs an information writing operation.

A fourth command is designed to designate an LBA on the hard disk 14, and then, to require to read the information. In the case where the fourth command is issued from the host apparatus 20, if it is judged that a region corresponding to a designated LBA has been already assigned on the flash memory 15 and that information newer than that in the hard disk 14 is stored in that region, the controller 16 needs to read the information from the flash memory 15.

In contrast, in the case where the same information is stored in both of the hard disk 14 and the flash memory 15, the controller 16 may read the information from the region corresponding to the LBA required to be read in the flash memory 15, or may read the information from the designated LBA in the hard disk 14.

In the case where the latest data is stored in the hard disk 14 although the region corresponding to the designated LBA has been already assigned on the flash memory 15, the controller 16 needs to read the information from the designated LBA in the hard disk 14. In the case where the controller 16 has read the information from the hard disk 14, it judges as to whether or not the information is cached in the flash memory 15.

Like the above-described third and fourth commands, an LBA, in which a region is assigned on the flash memory 15 and information is written in the assigned region on the flash memory 15, out of the LBAs, in or from which the information is required to be written or read, without any pinned attribute information is added with “unpinned” attribute information.

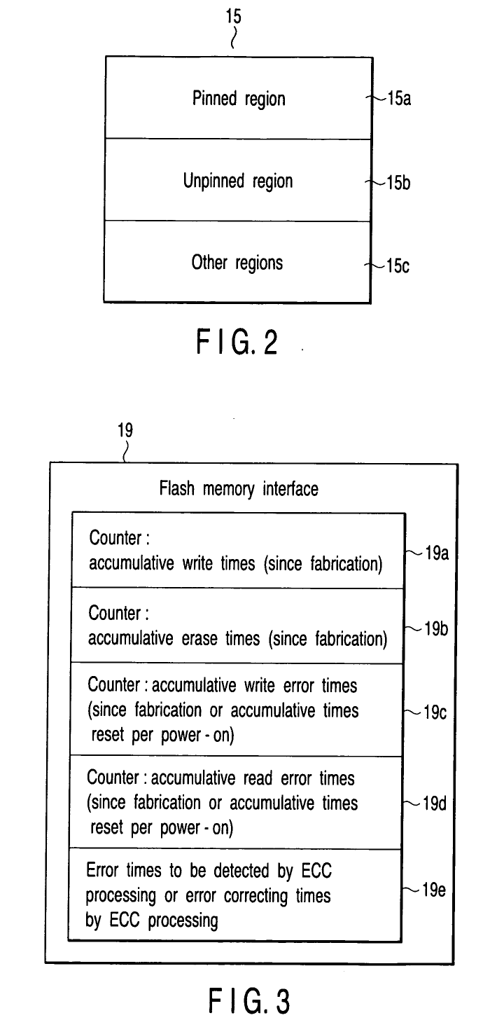

An LBA added with the pinned attribute information is referred to as “a pinned LBA”, and further, a region on the flash memory 15 corresponding to the pinned LBA is referred to as “a pinned region”. In contrast, an LBA added with the unpinned attribute information is referred to as “an unpinned LBA”, and further, a region on the flash memory 15 corresponding to the unpinned LBA is referred to as “an unpinned region”. As a consequence, a pinned region 15a, an unpinned region 15b and other regions 15c are formed on the flash memory 15, as illustrated in FIG. 2.

A fifth command requests to make a vacant region by a designated size inside the flash memory 15. When the host apparatus 20 issues the fifth command, the controller 16 secures the vacant region by the designated size inside the flash memory 15 by transferring information by the designated size or more from the unpinned region 15b in the flash memory 15 to the hard disk 14 if a vacant region at present in the flash memory 15 is smaller than a requested vacant region. In this case, the controller 16 determines on its own judgment as to information stored in which region in the unpinned region 15b in the flash memory 15 is transferred to the hard disk 14, that is, as to a vacant region is formed in which region in the flash memory 15.

Subsequently, explanation will be made on the above-described flash memory interface 19. The flash memory interface 19 has the function of connecting the controller 16 and the flash memory 15 to each other in such a manner as to freely transfer the information therebetween, and further, includes a variety of counters 19a to 19e, as illustrated in FIG. 3. Counts of the counters 19a to 19e are stored in, for example, a non-volatile memory, not shown, housed inside the flash memory interface 19. Incidentally, the counts may be stored by the use of the flash memory 15.

First of all, the counter 19a accumulatively counts writing times after fabrication. The counter 19b accumulatively counts erasing times after the fabrication. The counter 19c accumulatively counts writing error times after the fabrication or in such a manner as to be reset every time a power source is turned on. The counter 19d accumulatively counts reading error times after the fabrication or in such a manner as to be reset every time the power source is turned on. The counter 19e accumulatively counts error times to be detected by error checking and correcting (ECC) processing or error correcting times by the ECC processing. Degradation of the flash memory 15 can be judged based on the counts of the counters 19a to 19e.

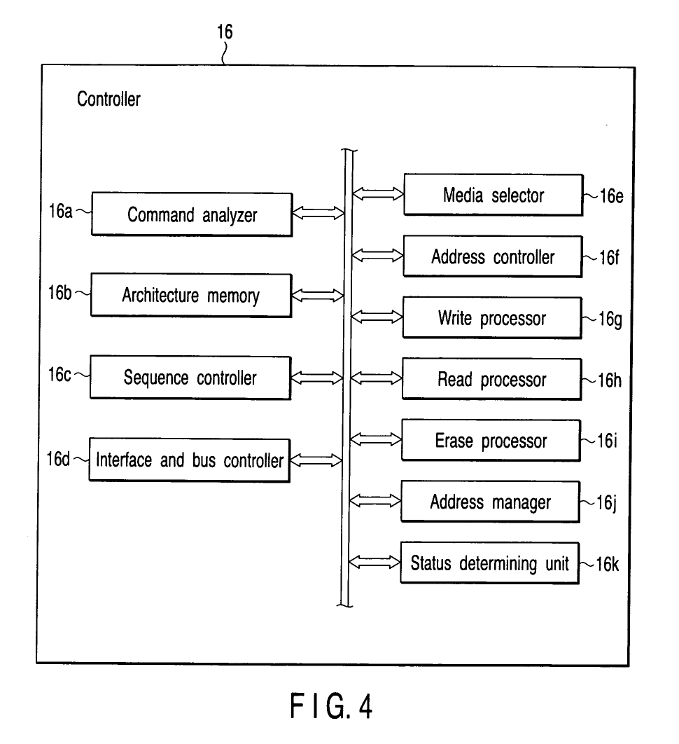

FIG. 4 illustrates one example of the controller 16. The controller 16 includes a command analyzer 16a for decoding and analyzing the command supplied from the host apparatus 20. Software in an architecture memory 16b is specified based on the analysis result by the command analyzer 16a, thereby setting operating procedures in a sequence controller 16c.

The sequence controller 16c controls the sequence of the information via an interface and bus controller 16d. For example, when the information is written or read, a media selector 16e specifies the flash memory 15 or the hard disk 14, and further, an address controller 16f specifies a writing address or a reading address.

Then, when the information is written, a writing processor 16g performs transferring processing or the like of information to be written. In contrast, when the information is read, a reading processor 16h performs transferring processing or the like of information to be read.

In addition, the controller 16 includes an erasing processor 16i. The erasing processor 16i performs erasing processing of the information recorded in the flash memory 15. Furthermore, the erasing processor 16i can also perform erasing processing of the information recorded in the hard disk 14.

Additionally, the controller 16 includes an address manager 16j. The address manager 16j comprehensively manages addresses of recorded regions or not-recorded regions in the flash memory 15 and the hard disk 14. Moreover, the controller 16 includes a status determining unit 16k for monitoring the drive status of the hard disk 14.

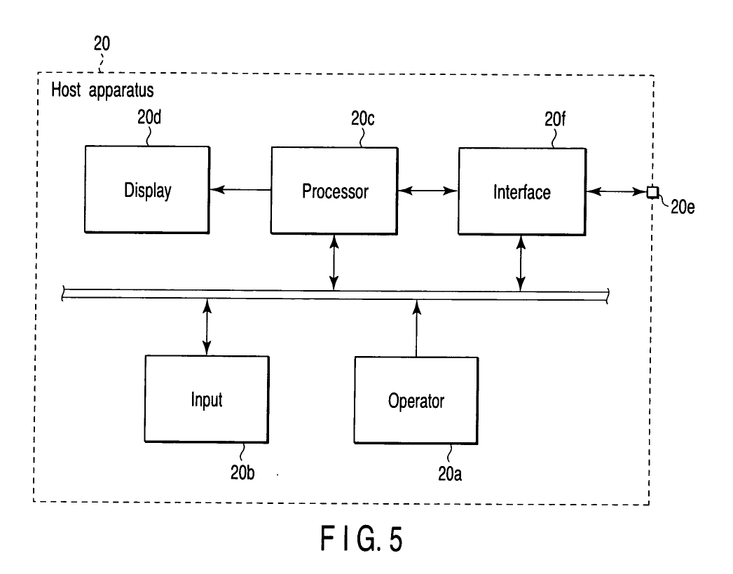

FIG. 5 illustrates one example of the host apparatus 20. The host apparatus 20 includes an operator 20a to be operated by a user, and an input 20b for acquiring information from an outside network or a predetermined information recording medium in accordance with the operation in the operator 20a.

In addition, the host apparatus 20 includes a processor 20c for subjecting the information acquired in the input 20b to a preset signal processing and producing a command with respect to the information recording apparatus 11, and a display 20d for displaying the processing result of the processor 20c.

Additionally, the host apparatus 20 includes an interface 20f for outputting the information or the command as the processing result of the processor 20c to the outside, that is, the information recording apparatus 11 via a connecting terminal 20e while supplying the information input from the outside, that is, the information recording apparatus 11 to the processor 20c via the connecting terminal 20e.

Here, since the flash memory 15 is smaller in recording capacity than the hard disk 14, the flash memory 15 is controlled to make a vacant region by transferring the information to the hard disk 14 based on the self-judgment of the controller 16 when the recording region is occupied in a predetermined quantity.

However, means for explicitly transferring (flashing) the information recorded in the flash memory 15, irrespective of the pinned region 15a and the unpinned region 15b, to the hard disk 14 so as to make a vacant region in the flash memory 15, is not defined on the above-described standard, and thus, a user cannot freely make a vacant region having a required size, as necessary.

Furthermore, the flash memory 15 is liable to be broken in comparison with the hard disk 14, and therefore, the information recorded in the flash memory 15 becomes much lower in reliability than that recorded in the hard disk 14. In other words, the information can be stored in the hard disk 14 with higher reliability than in the flash memory 15. In this case, if the information recorded in the flash memory 15 is corrupted before it is stored in the hard disk 14, the information recording apparatus 11 cannot output correct information in accordance with the reading command issued from the host apparatus 20.

In view of this, there is additionally provided a flash command for flashing the information recorded in the flash memory 15, irrespective of the pinned region 15a and the unpinned region 15b, to the hard disk 14 after the designation of the region, and then, for making a vacant region in the flash memory 15 in the present embodiment.

In this manner, the host apparatus 20 can issue the flash command at a predetermined timing based on its own judgment. Thereafter, the controller 16 flashes the information recorded in the designated region in the flash memory 15 to the hard disk 14 upon receipt of the flash command, and further, controls to erase the flashed information in the region from the flash memory 15. Thus, the information recorded in the flash memory 15 is flashed to the hard disk 14.

After the information recorded in the flash memory 15 is flashed to the hard disk 14, there is a vacant region in the flash memory 15. Therefore, management data stored in the above-described address manager 16j in the controller 16 is updated accordingly.

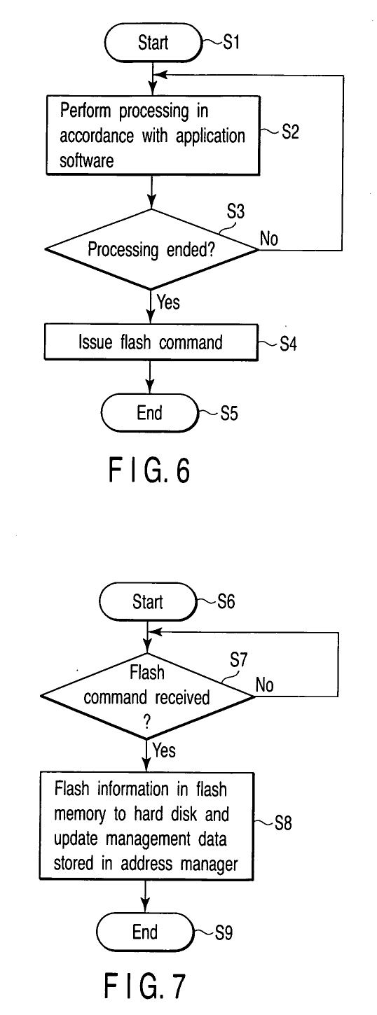

FIG. 6 illustrates one example of the flash command issuing processing at the predetermined timing by the host apparatus 20. Specifically, upon start of the processing (block S1), the processor 20c in the host apparatus 20 performs processing in accordance with given application software in block S2.

In the state in which the processing in accordance with the application software is performed, the processor 20c in the host apparatus 20 issues the writing command or the reading command with respect to the information recording apparatus 11. In the meantime, the controller 16 controls to write or read the information in or from the flash memory 15.

Thereafter, the processor 20c in the host apparatus 20 judges in block S3 whether or not the processing in accordance with the application software is ended. If it is judged that the processing is ended (YES), the flash command is issued to the information recording apparatus 11 in block S4, and then, the processing comes to an end (block S5).

FIG. 7 illustrates one example of the processing by the controller 16 upon receipt of the flash command. Specifically, upon start of the processing (block S6), the controller 16 judges in block S7 whether or not the flash command is received.

If it is judged that the flash command is received (YES), the controller 16 flashes and records the information recorded in the region in the flash memory 15 designated by the flash command to and in the hard disk 14 in block S8, and further, updates the management data stored in the address manager 16j. Thus, the processing comes to an end (block S9).

In the above-described embodiment, there is additionally provided the flash command for flashing the information recorded in the designated region of the flash memory 15, irrespective of the pinned region 15a and the unpinned region 15b, to the hard disk 14.

In this manner, the host apparatus 20 issues the flash command at the predetermined timing without waiting for the self judgment by the controller 16, and thus, can freely make the vacant region having an arbitrary size inside the flash memory 15 by flashing the information recorded in the flash memory 15 to the hard disk 14. Thus, it is possible to effectively use the recording region in the flash memory 15, and further, to achieve the easiness of use by the user.

Moreover, since the information recorded in the flash memory 15 is flashed to the hard disk 14 at the timing determined by the host apparatus 20, the possibility that the correct information is recorded in the hard disk 14 can be remarkably enhanced. Thus, the correct information is read and output from the hard disk 14 in accordance with the reading command issued from the host apparatus 20.

In addition, in the state in which the host apparatus 20 performs the processing in accordance with the predetermined application software, that is, in the state in which the information is frequently written in or read from the information recording apparatus 11, the controller 16 controls such that the information is written in or read from the flash memory 15. In contrast, in the state in which the host apparatus 20 ends the processing in accordance with the predetermined application software, that is, in the state in which no information is written in or read from the information recording apparatus 11, the flash command is issued such that the information in the flash memory 15 is flashed to the hard disk 14. Thus, it is possible to suppress the driving times of the hard disk 14 to the minimum, so as to save power consumption.

Additionally, the host apparatus 20 can speedily record information, which is judged to be low in future access frequency, in the hard disk 14 via the flash memory 15 by issuing the flash command together with the writing command when that information is written in the information recording apparatus 11.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording apparatus comprising:
an input configured to receive a command;
a disk-like recording medium;
a non-volatile memory configured to serve as a cache memory for the disk-like recording medium; and
a control unit configured to write information in the non-volatile memory in accordance with a writing command input into the input, to record the information recorded in the non-volatile memory in the disk-like recording medium at a predetermined timing, and to flash the information recorded in the non-volatile memory to the disk-like recording medium in accordance with a flash command input into the input so as to make a vacant region inside the non-volatile memory.

2. An information recording apparatus according to claim 1, wherein the control unit controls such that the information recorded in the non-volatile memory is transferred to and recorded in the disk-like recording medium, before the information recorded in the non-volatile memory is erased, thus making the vacant region.

3. An information recording apparatus according to claim 1, wherein the control unit controls such that the information recorded in a specified recording region designated by the non-volatile memory based on information, which is included in the flash command input into the input and designates the specified recording region in the non-volatile memory, is flashed to the disk-like recording medium.

4. An information recording apparatus according to claim 1, wherein the disk-like recording medium is a hard disk, and the non-volatile memory is a flash memory.

5. A host apparatus comprising:
with respect to an information recording apparatus including an input configured to receive a command, a disk-like recording medium, a non-volatile memory configured to serve as a cache memory for the disk-like recording medium, and a control unit configured to write information in the non-volatile memory in accordance with a writing command input into the input and to record the information recorded in the non-volatile memory in the disk-like recording medium at a predetermined timing,
a processor configured to issue a flash command which allows the control unit to flash the information recorded in the non-volatile memory to the disk-like recording medium so as to make a vacant region inside the non-volatile memory.

6. A host apparatus according to claim 5, wherein the processor issues the flash command upon completion of processing in accordance with a predetermined application software.

7. A host apparatus according to claim 5, wherein the processor issues the flash command in the case where information having a low access frequency is recorded in the information recording apparatus.

8. A host apparatus according to claim 5, wherein the processor allows the flash command to include information designating a specified recording region in the non-volatile memory.

9. A method for controlling an information recording apparatus comprising:
a first block of receiving a command;
a second block of writing information in a non-volatile memory serving as a cache memory for a disk-like recording medium in accordance with a writing command input in the first block;
a third block of recording the information recorded in the non-volatile memory in the second block in the disk-like recording medium at a predetermined timing; and
a fourth block of flashing the information recorded in the non-volatile memory to the disk-like recording medium in accordance with a flash command input in the first block, so as to make a vacant region inside the non-volatile memory.

10. A method for controlling an information recording apparatus according to claim 9, wherein in the fourth block, the information recorded in the non-volatile memory is transferred to and recorded in the disk-like recording medium, before the information recorded in the non-volatile memory is erased, thus making the vacant region.

11. A method for controlling an information recording apparatus according to claim 9, wherein in the fourth block, the information recorded in a specified recording region designated by the non-volatile memory is flashed to the disk-like recording medium based on information, which is included in the flash command input in the first block and designates the specified recording region in the non-volatile memory.
